(19) United States
(12) Patent Application Publication
(10) Pub. No.: US 2016/0257863 A1
(43) Pub. Date: Sep. 8, 2016

(54) BONDED MEMBER AND METHOD FOR PRODUCING THE SAME

(71) Applicant: ALPS ELECTRIC CO., LTD., Tokyo (JP)

(72) Inventor: Yoshinao Taniguchi, Miyagi-ken (JP)

(73) Assignee: Alps Electric Co., Ltd.

(21) Appl. No.: 15/156,445

(22) Filed: May 17, 2016

Related U.S. Application Data
(62) Division of application No. 14/930,280, filed on Nov. 2, 2015.
Application No. 14/930,280 is a continuation of application No. PCT/JP2014/062171, filed on May 2, 2014.

(30) Foreign Application Priority Data
May 2, 2013 (JP) 2013-096878

(51) Int. Cl. C09J 123/24; B32B 37/12; B32B 27/32; B32B 7/12

(52) U.S. Cl. CPC C09J 123/24; B32B 7/12; B32B 37/12; B32B 27/325; B32B 2551/00; B32B 2255/26

(57) ABSTRACT

A micro chip plate according to an embodiment includes a first substrate, a second substrate, and an adhesive layer, the first substrate and the second substrate being bonded to each other with the adhesive layer provided therebetween, in which each of the first substrate and the second substrate is composed of a cycloolefin polymer (COP) or a cycloolefin copolymer (COCA), and the adhesive layer contains a polymer of α-olefin.

### CLAIM OF PRIORITY

The present patent document is a divisional of U.S. application Ser. No. 14/930,280, filed on Nov. 2, 2015, which is a continuation of International Application No. PCT/JP2014/062171 filed on May 2, 2014, which claims benefit of Japanese Patent Application No. 2013-096878 filed on May 2, 2013. The entire contents of each application noted above are hereby incorporated by reference.

### BACKGROUND

1. Field of the Disclosure

The present disclosure relates to a bonded member, such as a micro chip plate, in which substrates composed of a cycloolefin polymer (COP) or a cycloolefin copolymer (COCA) are bonded to each other with an adhesive layer provided therebetween and a method for producing the bonded member.

2. Description of the Related Art

International Publication No. WO2009/131070 discloses an invention that relates to a bonded member in which a first substrate and a second substrate composed of a cycloolefin polymer (COP) or a cycloolefin copolymer (COCA) are bonded to each other with an adhesive layer composed of paraffin or the like.

International Publication No. WO2009/131070 states that this allows the first substrate and the second substrate to be appropriately bonded to each other and to be adjusted to have low fluorescence.

However, it was found that although the bonded member had sufficient mechanical strength in normal use, the adhesive layer tended to have relatively low resistance to a tear force.

### SUMMARY

A bonded member includes a first substrate, a second substrate, and an adhesive layer, the first substrate and the second substrate being bonded to each other with the adhesive layer provided therebetween, in which each of the first substrate and the second substrate is composed of a cycloolefin polymer (COP) or a cycloolefin copolymer (COCA), and the adhesive layer contains a polymer of α-olefin.

In another aspect, a method for producing a bonded member including a first substrate, a second substrate, and an adhesive layer, the first substrate and the second substrate being bonded to each other with the adhesive layer provided therebetween, includes: applying an adhesive containing α-olefin and a polymerization initiator to at least one of a facing surface of the first substrate and a facing surface of the second substrate, each of the first substrate and the second substrate being composed of a cycloolefin polymer (COP) or a cycloolefin copolymer (COCA); and bonding the first substrate and the second substrate with the adhesive while the facing surface of the first substrate and the facing surface of the second substrate are allowed to face each other with the adhesive provided therebetween.

### BRIEF DESCRIPTION OF THE DRAWINGS

FIG. 1 is a partial cross-sectional view, taken in the thickness direction, of a micro chip plate according to an embodiment of the present invention;

FIGS. 2A and 2B are schematic views illustrating an adhesion mechanism by which a first substrate and a second substrate are bonded to each other with an adhesive layer provided therebetween;

FIG. 3A is a perspective view of a measurement sample used for an experiment;

FIG. 3B is a graph illustrating the relationship between the tensile time and the adhesive strength when a tear experiment was performed with samples according to an example and a comparative example;

FIG. 4A is a schematic diagram of a method for measuring pressure resistance; and

FIG. 4B is a graph illustrating the relationship between the liquid injection time and the pressure when an experiment that aims at studying the effect of a polymerization initiator in channels was performed with the samples according to the example and the comparative example.

### DESCRIPTION OF THE EXEMPLARY EMBODIMENTS

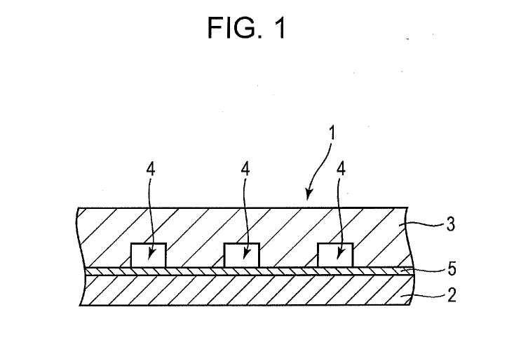

FIG. 1 is a partial cross-sectional view, taken in the thickness direction, of a micro chip plate according to an embodiment of the present invention.

A micro chip plate 1 according to the embodiment includes, for example, a first substrate 2 having a thin flat plate shape (film shape), a second substrate 3 having a flat plate shape (plate shape), higher stiffness than that of the first substrate 2, and channels 4 or the like formed on a surface of the first substrate 2 adjacent to the first substrate 2, and an adhesive layer 5 configured to bond the first substrate 2 and the second substrate 3 to each other.

Each of the first substrate 2 and the second substrate 3 is composed of a cycloolefin polymer (COP) or a cycloolefin copolymer (COCA).

Examples of COP that may be preferably used include Zeonex and Zeonor (trade name, manufactured by Zeon Corporation); and Arton (trade name, manufactured by JSR Corporation). Examples of COCA that is preferably used include Optorez (trade name, manufactured by Hitachi Chemical Company, Ltd.); and Topas (trade name, manufactured by Polyplastics Co., Ltd).

In the foregoing embodiment, the first substrate 2 has a film shape, and the second substrate 3 has a plate shape. However, the shape of each of the first substrate 2 and the second substrate 3 is not limited thereto. For example, each of the first substrate 2 and the second substrate 3 may have a thick plate shape.

Each of the first substrate 2 and the second substrate 3 is preferably formed of a sheet with a thickness of 10 μm to 10 mm. The term “sheet” includes the plate shape and the film shape described above.

For example, in the case where the first substrate 2 has a film shape, the first substrate 2 has a thickness of about 500 μm, and the second substrate 3 with a plate shape has a thickness of about 0.5 to about 10 mm.

In the embodiment, the adhesive layer 5 contains a polymer of α-olefin (1-alkene) represented by (Chem. 1) described below. The adhesive layer 5 has a thickness of about 1 to about 100 μm.

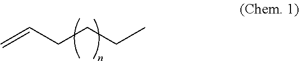

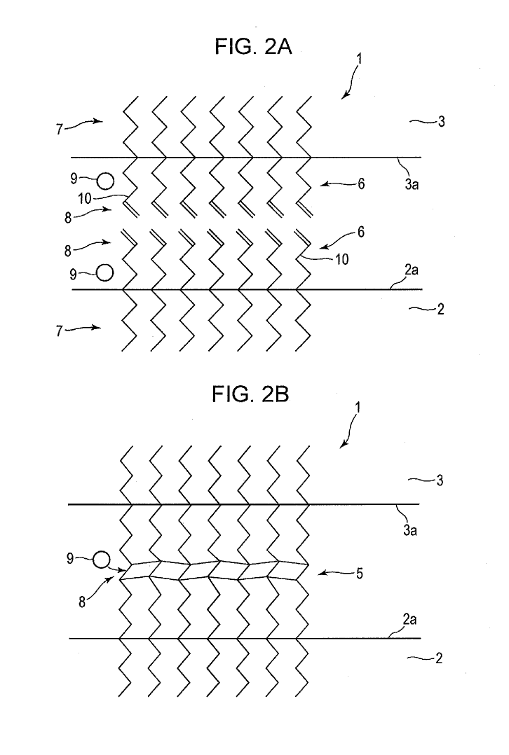

The cycloolefin polymer (COP), the cycloolefin copolymer (COCA), and α-olefin are nonpolar substances. Thus, the intermolecular forces of the cycloolefin polymer (COP) and the cycloolefin copolymer (COCA) are not significantly different from the intermolecular force of α-olefin. The intermolecular forces are weak, so that when their molecules are exchanged with each other, their energies are not very different. The molecules are mixed together and stabilized. Thus, the alkane moiety of α-olefin enters COP or COCA. FIG. 2A is a schematic view illustrating a stage before bonding and after the application of an adhesive 6 containing α-olefin 10 to surfaces 2a and 3a (facing surfaces of the first and second substrates 2 and 3) of the first and second substrates 2 and 3.

As illustrated in FIG. 2A, alkane moieties 7 of molecules of the α-olefin 10 are stably mixed with the COP or COCA contained in the first substrate 2 and the second substrate 3 to enter the first and second substrates 2 and 3. It is presumed that double-bond moieties 8 located at the ends of molecules of the α-olefin 10 do not enter the first and second substrates 2 and 3 and are left on the side of surfaces 2a and 3a of the first and second substrates 2 and 3.

The adhesive 6 applied to the surfaces 2a and 3a of the first and second substrates 2 and 3 contains a polymerization initiator 9. The proportion of the polymerization initiator 9 in the adhesive 6 is preferably in the range of 0.3% by weight or more and 3% by weight or less. The range has been derived from experiments described below.

The type of the polymerization initiator 9 (cross-linking agent) is not particularly limited. Examples of an initiator that may be used as the polymerization initiator 9 include organic peroxides, such as bis(4-tert-butylcyclohexyl)peroxydicarbonate (trade name: Percadox 16, manufactured by Kayaku Akuzo Corporation, 10-hour half-life temperature=44° C.), tert-hexyl peroxypivalate (trade name: Perhexyl PV, manufactured by NOF Corporation, 10-hour half-life temperature=53° C.), 3,5,5-trimethylhexanoyl peroxide (trade name: Peroyl 355, manufactured by NOF Corporation, 10-hour half-life temperature=59° C.), lauroyl peroxide (trade name: Peroyl L, manufactured by NOF Corporation, 10-hour half-life temperature=62° C.), tert-hexyl peroxy-2-ethylhexanoate (trade name: Perhexyl O, manufactured by NOF Corporation, 10-hour half-life temperature=70° C.), tert-butyl peroxy-2-ethylhexanoate (trade name: Perbutyl O, manufactured by NOF Corporation, 10-hour half-life temperature=72° C.), benzoyl peroxide (trade name: Cadox B-CH50, manufactured by Kayaku Akuzo Corporation, 10-hour half-life temperature=72° C.), di-tert-butylperoxy-2-methylcyclohexane (trade name: Perhexa MC, manufactured by NOF Corporation, 10-hour half-life temperature=83° C.), 1,1-bis(tert-hexylperoxy)-3,3,5-trimethylcyclohexane (trade name: Perhexa TMH, manufactured by NOF Corporation, 10-hour half-life temperature=87° C.), 1,1-bis(tert-hexylperoxy)cyclohexane (trade name: Perhexa HC, manufactured by NOF Corporation, 10-hour half-life temperature=87° C.), 1,1-bis(tert-butylperoxy)-3,3,5-trimethylcyclohexane (trade name: Perhexa 3M, manufactured by NOF Corporation, 10-hour half-life temperature=90° C.), 1,1-bis(tert-butylperoxy)cyclohexane (trade name: Perhexa C, manufactured by NOF Corporation, 10-hour half-life temperature=91° C.), 1,1-bis(tert-butylperoxy)cyclododecane (trade name: Perhexa CD, manufactured by NOF Corporation, 10-hour half-life temperature=95° C.), tert-hexyl peroxyisopropylcarbonate (10-hour half-life temperature=95° C.), tert-amyl peroxy-3,5,5-trimethylhexanoate (trade name: Kayaester AN, manufactured by Kayaku Akuzo Corporation, 10-hour half-life temperature=95° C.), 1,6-bis(tert-butylperoxycarbonyloxy)hexane (trade name: Kayalene 6-70, manufactured by Kayaku Akuzo Corporation, 10-hour half-life temperature=97° C.), tert-butyl peroxylaurate (trade name: Perbutyl L, manufactured by NOF Corporation, 10-hour half-life temperature=98° C.), tert-butyl peroxyisopropylcarbonate (trade name: Perbutyl I, manufactured by NOF Corporation, 10-hour half-life temperature=99° C.), tert-butyl peroxy-2-ethylhexylcarbonate (trade name: Perbutyl E, manufactured by NOF Corporation, 10-hour half-life temperature=99° C.), tert-hexyl peroxybenzoate (trade name: Perhexyl Z, manufactured by NOF Corporation, 10-hour half-life temperature=99° C.), tert-butyl peroxy-3,5,5-trimethylhexanoate (trade name: Trigonox 42, manufactured by Kayaku Akuzo Corporation, 10-hour half-life temperature=100° C.), tert-amyl peroxybenzoate (trade name: KD-1, manufactured by Kayaku Akuzo Corporation, 10-hour half-life temperature=100° C.), 2,2-bis(tert-butylperoxy)butane (trade name: Perhexa 22, manufactured by NOF Corporation, 10-hour half-life temperature=103° C.), tert-butyl peroxybenzoate (trade name: Perbutyl Z, manufactured by NOF Corporation, 10-hour half-life temperature=104° C.), n-butyl 4,4-bis(tert-butylperoxy)valerate (trade name: Perhexa V, manufactured by NOF Corporation, 10-hour half-life temperature=105° C.), dicumyl peroxide (trade name: Percumyl D, manufactured by NOF Corporation, 10-hour half-life temperature=116° C.), and 1,3-bis(tert-butylperoxyisopropyl) benzoate (trade name: Percadox 14, manufactured by Kayaku Akuzo Corporation, 10-hour half-life temperature=121° C.); initiators, such as azo compounds having cross-linked structures, for example, 2,2′-azobis-2,4-dimethylvaleronitrile (trade name: ADVN, manufactured by Otsuka Chemical Co., Ltd., 10-hour half-life temperature=52° C.), 1,1′-azobis(1-acetoxy-1-phenylethane) (trade name: OTAZO-15, manufactured by Otsuka Chemical Co., Ltd., 10-hour half-life temperature=61° C.), 2,2′-azobisisobutylonitrile (trade name: AIBN, manufactured by Otsuka Chemical Co., Ltd., 10-hour half-life temperature=65° C.), 2,2′-azobis-2-methylbutylonitrile (trade name: AMEN, manufactured by Otsuka Chemical Co., Ltd., 10-hour half-life temperature=67° C.), dimethyl-2,2′-isobutyrate (manufactured by Otsuka Chemical Co., Ltd., trade name: MAIB, 10-hour half-life temperature=67° C.), 1,1′-azobis-l-cyclohexanecarbonitrile) (trade name: ACHN, manufactured by Otsuka Chemical Co., Ltd., 10-hour half-life temperature=87° C.); isocyanate-based cross-linking agents; aziridine-based cross-linking agents; Coronate HL (hexamethylene diisocyanate, HDI-TMP adduct) manufactured by Tosoh Corporation; BXX5134 (aziridine-based cross-linking agent) manufactured by Toyo Ink Mfg. Co., Ltd.,; Epocros RPS-1005 (oxazoline-based cross-linking agent) manufactured by Nippon Shokubai Co., Ltd.; and TETRAD-X and TETRAD-C (both are epoxy-based cross-linking agents) manufactured by Mitsubishi Gas Chemical Company, Inc.

A polymerization method using a Ziegler-Natta-based catalyst may be employed.

Examples of the polymerization method include polymerization methods using Ziegler-Natta-based catalysts described in Polymer J., 10, 619 (1978), Macromol. Chem., 190, 2683 (1989), Makromol. Chem., Rapid Comm., 13, 447 (1992), and Japanese Unexamined Patent Application Publication No. 7-145205, and so forth.

Macromol. Sci. Pure Appl. Chem., A35, 473 (1998), J. Polym. Sci. A, 38, 233 (2000), Macromol. Mater. Eng., 286, 480 (2001), and Macromol. Mater. Eng., 286, 350 (2001) describe the use of homogeneous catalysts called metallocene catalysts. Polymerization methods using the homogeneous catalysts may also be employed.

The surfaces 2a and 3a (facing surfaces) of the first and second substrates 2 and 3 are arranged with the adhesive 6 provided therebetween so as to face each other. The first substrate 2 and the second substrate 3 are press and bonded together by, for example, hot pressing under heat. At this time, bonding conditions, i.e., bonding temperature, bonding pressure, and bonding time, are appropriately adjusted.

As illustrated in FIG. 2B, the polymerization of the double-bond moieties 8 are performed using the polymerization initiator 9. As a result, the first substrate 2 and the second substrate 3 are bonded to each other with the adhesive layer 5 provided therebetween, the adhesive layer 5 containing a polymer of the α-olefin. As illustrated in FIG. 2B, the polymerization is also transversely performed to allow the resulting polymerized portion to have three-dimensional network structure.

For example, in the case where the adhesive used to bond the substrates together is composed of paraffin or alkane, polymerization does not occur because each of the paraffin and alkane does not have a double bond.

Hence, in the embodiment in which the adhesive layer 5 contains the polymer of the α-olefin, the adhesive strength between the first substrate 2 and the second substrate 3 is higher than that in a comparative example in which the adhesive layer 5 is composed of paraffin or alkane. In particular, in the structure of the comparative example, the adhesive strength is disadvantageously low with respect to a tear force. In contrast, the embodiment provides the structure having high resistance to the tear force.

The α-olefin preferably has a carbon number of 3 or more and 20 or less. In this case, both of the entry of the alkane moieties 7 of molecules of the α-olefin to the first and second substrates 2 and 3 and the polymerization of the double-bond moieties 8 are appropriately achieved to effectively enhance the adhesive strength.

Regarding the α-olefin, 1-hexadecene (carbon number: 16) is preferably selected. In this case, high adhesive strength was provided as stated in experimental results described below.

In the micro chip plate (bonded member) 1 illustrated in FIG. 1, the channels 4 are arranged between the first substrate 2 and the second substrate 3. Although the channels 4 illustrated in FIG. 1 are arranged on the side of one substrate (second substrate 3), the channels 4 may be arranged on both of the first and second substrates 2 and 3.

In the micro chip plate 1 including the channels 4 according to the embodiment, the first substrate 2 and the second substrate 3 are strongly bonded to each other with the adhesive layer 5 containing the polymer of the α-olefin in a portion other than the channels 4. It is thus possible to effectively enhance the adhesive strength of the micro chip plate 1 even when the micro chip plate 1 includes the channels 4.

In a method for producing the micro chip plate (bonded member) 1, as illustrated in FIG. 2A, the adhesive 6 containing the α-olefin 10 and the polymerization initiator 9 is preferably applied to both of the surfaces (facing surfaces) 2a and 3a of the first and second substrates 2 and 3. For example, the first substrate 2 and the second substrate 3 may be bonded to each other with the adhesive 6 applied only to one of the surfaces 2a and 3a of the first and second substrates 2 and 3. However, as illustrated in FIG. 2A, the application of the adhesive 6 to both of the surfaces 2a and 3a allows the alkane moieties 7 of molecules of the α-olefin 10 to enter the first and second substrates 2 and 3 and allows the double-bond moieties 8 of molecules of the α-olefin 10 to protrude from the surfaces 2a and 3a. In this case, as illustrated in FIG. 2B, the polymerization of the double-bond moieties 8 present on the surfaces 2a and 3a further effectively improves the adhesive strength between the first substrate 2 and the second substrate 3.

Furthermore, the copolymerization of these double bonds and a double bond-containing monomer, such as methyl methacrylate, may also improve the adhesive strength.

The polymer of the α-olefin according to the embodiment includes a polymer of the α-olefin alone and a copolymer of the α-olefin and a monomer.

The embodiment is not limited to the micro chip plate and may be used for all bonded members, such as optical members, each of the bonded members including substrates that are bonded to each other with an adhesive layer provided therebetween, the substrates being composed of COP or COCA.

### EXAMPLES

Samples listed in Table 1 described below were produced.

TABLE 1

| | | Amount of | | |
|---|---|---|---|---|
| | | polymerization | | |
| Sample | Adhesive agent | initiator | | Adhesive strength |
| Comparative | 1-hexadecene | 0% | by weight | poor |
| Example 1 | | | | |
| Comparative | paraffin (molecular | 0% | by weight | poor |
| Example 2 | weight: 240) | | | |
| Comparative | hexadecane | 0% | by weight | poor |
| Example 3 | | | | |
| Example 1 | 1-hexadecene + | 0.3% | by weight | good |
| Example 2 | polymerization | 1.0% | by weight | excellent |

| | | | |
|---|---|---|---|
| Example 3 | initiator | 3% by weight | excellent |
| | | (saturated) | |

In Comparative Example 1, 1-hexadecene (α-paraffin) was used as an adhesive for a first substrate and a second substrate composed of a cycloolefin polymer (COP). In Comparative Example 1, no polymerization initiator was incorporated into the adhesive.

In Comparative Example 2, paraffin (molecular weight: 240) was used as an adhesive for a first substrate and a second substrate composed of a cycloolefin polymer (COP).

In Comparative Example 3, hexadecene was used as an adhesive for a first substrate and a second substrate composed of a cycloolefin polymer (COP).

In Example 1, a first substrate and a second substrate composed of a cycloolefin polymer (COP) were bonded to each other with an adhesive containing 1-hexadecene (α-paraffin) and a polymerization initiator (0.3% by weight).

In Example 2, a first substrate and a second substrate composed of a cycloolefin polymer (COP) were bonded to each other with the adhesive containing 1-hexadecene (α-paraffin) and the polymerization initiator (1.0% by weight).

In Example 3, a first substrate and a second substrate composed of a cycloolefin polymer (COP) were bonded to each other with the adhesive containing 1-hexadecene (α-paraffin) and the polymerization initiator (3% by weight, saturated).

In each of the samples, the bonding was performed for a bonding time of 5 minutes at a bonding temperature of 100° C. and a bonding pressure of 4.2 MPa. In Examples 1, 2, and 3, dimethyl 2,2′-azobis(2-methylpropionate) (trade name: V-601, manufactured by Wako Pure Chemical Industries, Ltd., molecular weight: 230.26) was used as the polymerization initiator. The amount of the polymerization initiator added in each of Examples 1, 2, and 3 was indicated by the proportion (% by weight) in the adhesive.

In each of the samples, the first substrate and the second substrate each having a narrow-plate shape were arranged in the shape of a cross. The first and second substrates were bonded to each other with the foregoing adhesive applied to the overlapping portions of the substrates. In this experiment, a force was applied at a speed of 10 mm per minute in a direction in which the first substrate and the second substrate were separated from each other.

In each of Comparative Examples 1, 2, and 3, the separation started from a portion of the adhesive layer. In Example 1, a separated portion of the adhesive layer was smaller than those in the comparative examples, and the substrates were broken. In each of Examples 2 and 3, a separated portion of the adhesive layer was smaller than that in Example 1, and the substrates were broken.

The results of the experiment demonstrate that substantially the same and maximum adhesive strength between the first substrate and the second substrate was provided in Example 2 and 3. The adhesive strength in Example 1 was lower than those in Examples 2 and 3 and higher than those in Comparative Examples 1, 2, and 3. In each of Comparative Examples 1, 2, and 3, the adhesive layer was torn by the tear force; hence, the adhesive strength was low.

In each of Examples 1, 2, and 3, the double bonds of molecules of the α-olefin contained in the adhesive were presumed to react (polymerize) into a polymer, thereby improving the adhesive strength. The upper limit of the amount of the polymerization initiator was 3% by weight, which was the saturated amount. The lower limit of the amount of the polymerization initiator was preferably 0.3% by weight, which was used in the experiment, because a too small amount of the polymerization initiator reduced the rate of polymerization to reduce the adhesive strength.

Next, the relationship between the tensile time and the strength was studied using samples 1 and 2 described below.

In sample 1 (comparative example), Linealene (registered trademark, manufactured by Idemitsu Kosan Co., Ltd.) was used as an adhesive for a first substrate and a second substrate composed of a cycloolefin polymer (COP).

In sample 2 (example), a first substrate and a second substrate composed of a cycloolefin polymer (COP) were bonded to each other with an adhesive containing Linealene (registered trademark, manufactured by Idemitsu Kosan Co., Ltd.), which was an α-olefin, and 0.3% by weight of a polymerization initiator. Dimethyl 2,2′-azobis(2-methylpropionate) (trade name: V-601, manufactured by Wako Pure Chemical Industries, Ltd., molecular weight: 230.26) was used as the polymerization initiator. In sample 2, the amount of the polymerization initiator added was indicated by the proportion in the adhesive.

In each of the samples, the bonding was performed for a bonding time of 5 minutes at a bonding temperature of 80° C. and a bonding pressure of 4.2 MPa.

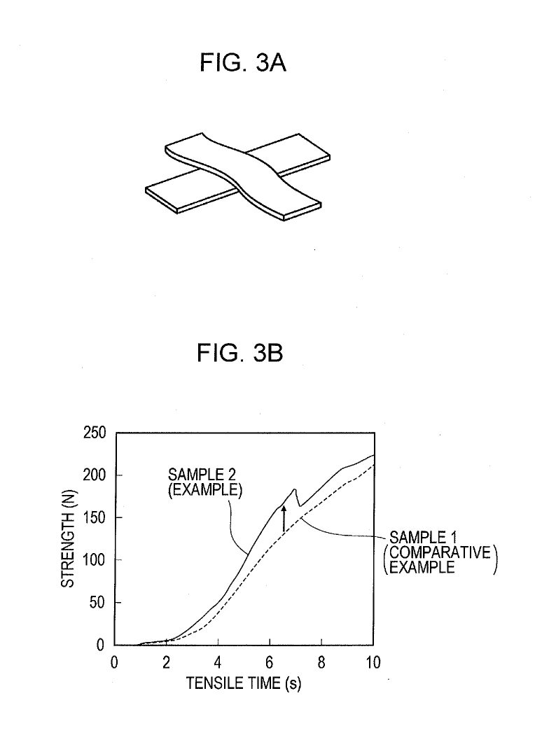

In this experiment, as illustrated in FIG. 3A, COP plates (76 mm in length and 1 mm in thickness) were bonded together in the shape of a cross and fixed with a jig. A force was applied at a tensile speed of 10 mm per minute in a direction in which the COP plates were separated from each other. FIG. 3B illustrates the relationship between the tensile time and the strength of the samples. In the case where the force was applied in the direction of separation, a higher slope of the data plots illustrated in FIG. 3B indicated higher adhesive strength. The results demonstrated that the adhesive strength of sample 2 (example) was higher than that of sample 1 (comparative example).

In sample 2 (example), 0.3% by weight of the polymerization initiator was added to Linealene (registered trademark, manufactured by Idemitsu Kosan Co., Ltd.), which was an α-olefin. The results demonstrated that even at a proportion of the polymerization initiator of 0.3% by weight, the effect of improving the adhesive strength was provided.

Next, sample 3 (comparative example) and sample 4(example) of micro chip plates including channels as illustrated in FIG. 1 were produced, the sample 3 including the same adhesive as in Comparative Example 1 listed in Table 1, and sample 4 including the same adhesive as in Example 2 listed in Table 1. The relationship between the liquid injection time and the pressure was studied using the samples 3 and 4.

In each of the samples, the bonding was performed for a bonding time of 5 minutes at a bonding temperature of 110° C. and a bonding pressure of 4.6 MPa.

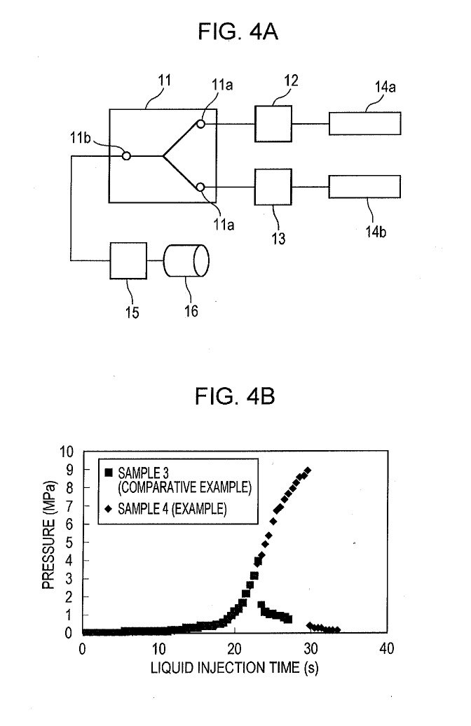

Each of the plates measured 5 mm x 5 mm and had a minimum channel width of 0.1 mm and a channel area of 250 mm². Specifically, plates 11 illustrated in FIG. 4A were produced. Each of the plates 11 included liquid inlets 11a and 11a. Pressure sensors 12 and 13 were arranged in the liquid inlets 11a and 11a. Liquid was injected with pumps 14a and 14b.

A pressure sensor 15 was arranged in a liquid outlet 11b of each plate 11 and connected to a regulator 16. An end of the plate on the liquid outlet 11b side was plugged.

The liquid was injected into the channels of each sample at a feed rate of 0.1 mL/min, and the relationship between the liquid injection time and the pressure was studied.

As illustrated in FIG. 4B, in the sample including the adhesive used in Comparative Example 1, the pressure was reduced from a liquid injection time of about 22 seconds. Thus, the tearing or the like of the adhesive layer was presumed to occur. In the sample including the adhesive used in Example 2, a high pressure was observed even after the liquid injection time at which the pressure was reduced in the comparative example. The results demonstrated that the adhesive strength between the first substrate and the second substrate was maintained at a high level.

Unlike sample 3 (comparative example), the polymerization initiator was incorporated into the adhesive in sample 4 (example), so that the adhesive layer contained the polymer of the α-olefin in sample 4 (example). Thus, the adhesive strength of sample 4 (example) was higher than that of sample 3 (comparative example) that did not contain a polymerization initiator.

What is claimed is:

1. A method for producing a bonded member including a first substrate, a second substrate, and an adhesive layer, the first substrate and the second substrate being bonded to each other with the adhesive layer provided therebetween, the method comprising:
applying an adhesive containing α-olefin and a polymerization initiator to at least one of a facing surface of the first substrate and a facing surface of the second substrate, each of the first substrate and the second substrate being composed of a cycloolefin polymer (COP) or a cycloolefin copolymer (COCA); and
bonding the first substrate and the second substrate with the adhesive while the facing surface of the first substrate and the facing surface of the second substrate are allowed to face each other with the adhesive provided therebetween.

2. The method according to claim 1,
wherein the α-olefin has a carbon number n of 3 or more and 20 or less.

3. The method according to claim 2,
wherein the α-olefin is 1-hexadecene.

4. The method according to claim 1,
wherein the proportion of the polymerization initiator in the adhesive is in the range of 0.3% by weight or more and 3% by weight or less.

5. The method according to claim 1,
wherein the adhesive is applied to both of the facing surface of the first substrate and the facing surface of the second substrate.

6. The method according to claim 1,
wherein a channel is formed on at least one of the facing surface of the first substrate and the facing surface of the second substrate, and
the facing surface of the first substrate and the facing surface of the second substrate are bonded to each other with the adhesive provided therebetween.

7. The method according to claim 2,
wherein the adhesive is applied to both of the facing surface of the first substrate and the facing surface of the second substrate.

8. The method according to claim 3,
wherein the adhesive is applied to both of the facing surface of the first substrate and the facing surface of the second substrate.

9. The method according to claim 4,
wherein the adhesive is applied to both of the facing surface of the first substrate and the facing surface of the second substrate.

10. The method according to claim 2,
wherein a channel is formed on at least one of the facing surface of the first substrate and the facing surface of the second substrate, and
the facing surface of the first substrate and the facing surface of the second substrate are bonded to each other with the adhesive provided therebetween.

11. The method according to claim 3,
wherein a channel is formed on at least one of the facing surface of the first substrate and the facing surface of the second substrate, and
the facing surface of the first substrate and the facing surface of the second substrate are bonded to each other with the adhesive provided therebetween.

12. The method according to claim 4,
wherein a channel is formed on at least one of the facing surface of the first substrate and the facing surface of the second substrate, and
the facing surface of the first substrate and the facing surface of the second substrate are bonded to each other with the adhesive provided therebetween.

13. The method according to claim 5,
wherein a channel is formed on at least one of the facing surface of the first substrate and the facing surface of the second substrate, and
the facing surface of the first substrate and the facing surface of the second substrate are bonded to each other with the adhesive provided therebetween.
